(19) United States
(12) Patent Application Publication
(10) Pub. No.: US 2024/0295457 A1
(43) Pub. Date: Sep. 5, 2024

(54) SEAL-INTEGRITY DIAGNOSTIC SYSTEM

(71) Applicant: Apple Inc., Cupertino, CA (US)

(72) Inventors: Ankur AGRAWAL, Santa Clara, CA (US); Krishna Prasad VUMMIDI MURALI, Sunnyvale, CA (US); Michael J. GLICKMAN, Mountain View, CA (US); Roberto M. RIBEIRO, Sunnyvale, CA (US); Terrance P. KAO, Saratoga, CA (US); Vincenzo COSTANZA, San Diego, CA (US)

(21) Appl. No.: 18/426,198

(22) Filed: Jan. 29, 2024

Related U.S. Application Data
(60) Provisional application No. 63/449,255, filed on Mar. 1, 2023.

(51) Int. Cl. G01M 3/32; G01M 13/005

(52) U.S. Cl. CPC G01M 3/3272; G01M 13/005

(57) ABSTRACT

An apparatus of the subject technology includes a housing, a first sensor to obtain a first measurement, an optional second sensor to obtain a second measurement, and a processor to determine a seal-quality metric of the housing based on the first measurement and the second measurement. The first sensor can include an internal pressure sensor disposed inside the housing, and the first measurement can include measurement of an internal pressure of the housing. The second sensor can include an external pressure sensor disposed at an outside wall of the housing, and the second measurement can include measurement of an external pressure.

### CROSS-REFERENCE TO RELATED APPLICATION(S)

This application claims the benefit of U.S. Provisional Application Ser. No. 63/449,255, entitled “SEAL-INTEGRITY DIAGNOSTIC SYSTEM,” and filed on Mar. 1, 2023, the disclosure of which is expressly incorporated by reference herein in its entirety.

### TECHNICAL FIELD

The present description relates generally to electronic devices, for example, to an electronic device having a seal-integrity diagnostic system.

### BACKGROUND

Electronic devices, such as watches and phones, are increasingly being used during water-based activities, for example, swimming, scuba diving, showering, and other water-based activities. Therefore, seal integrity plays an important role in the proper functioning of the devices as water ingress could damage the internal electronic components

Although electronic devices are tested for seal integrity before shipping, they could become compromised during the course of their use because of wear and tear, cracks, corrosion, and the like. A built-in seal-integrity diagnostics system could help users gain confidence on seal integrity of their devices and warn them of potential issues before they take the devices to water-based activities.

### BRIEF DESCRIPTION OF THE DRAWINGS

Certain features of the subject technology are set forth in the appended claims. However, for the purpose of explanation, several embodiments of the subject technology are set forth in the following figures.

FIG. 1 is a high-level block diagram illustrating an example of a system within which certain aspects of the subject technology are implemented.

FIG. 2 is a schematic diagram illustrating an example of an apparatus using a seal-integrity diagnostic system, according to one or more implementations of the subject technology.

FIG. 3 is a schematic diagram illustrating an example of a system with seal-integrity diagnostic features, according to one or more implementations of the subject technology.

FIGS. 4A and 4B are charts illustrating examples of pressure-change time variations of an acoustic seal-integrity diagnostic device, according to one or more implementations of the subject technology.

FIG. 4C is a chart illustrating an example of time variations of pressure-change due to temperature change of an acoustic seal-integrity diagnostic device, according to one or more implementations of the subject technology.

FIG. 5 is a flow diagram illustrating an example of a process for seal-integrity diagnosis, according to one or more implementations of the subject technology.

FIG. 6 is a flow diagram illustrating an example of a process for acoustic seal-integrity diagnosis, according to one or more implementations of the subject technology.

FIG. 7 is a flow diagram illustrating an example of a process for seal-integrity diagnosis, according to one or more implementations of the subject technology.

FIG. 8 is a flow diagram illustrating an example of a process for seal-integrity diagnosis, according to one or more implementations of the subject technology.

FIG. 9 is a schematic diagram illustrating an example of an electronic device within which aspects of the subject technology may be implemented.

### DETAILED DESCRIPTION

The detailed description set forth below is intended as a description of various configurations of the subject technology, and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein, and can be practiced using one or more other implementations. In one or more implementations, structures and components are shown in block diagram form in order to avoid obscuring the concepts of the subject technology.

In some aspects, the subject technology is directed to an electronic device having a seal-integrity diagnostic system. In some embodiments, an electronic device of the subject technology includes a housing, a first sensor, a second sensor, and a processor. The first sensor obtains a first measurement, and the second sensor obtains a second measurement. In one or more implementations, the first sensor is a pressure sensor that measures pressure, and the first measurement includes measurement of a first pressure that is an internal pressure of the housing. In one or more other implementations, the second sensor is also a pressure sensor that measures pressure, and the second measurement includes measurement of a second pressure that is an external pressure. The processor determines a seal-quality metric of the housing based on the first pressure and the second pressure.

The seal-quality metric is measure of a level of a leak of the housing. In some embodiments, the processor activates a pressure-change stimulus to cause a change in the first pressure. The pressure-change stimulus can be a touch stimulus that is activated by sending a message to a user. In some embodiments, the electronic device of the subject technology further includes an audio driver, and a speaker, and the pressure-change stimulus is an audio stimulus. For example, the processor can activate the pressure-change stimulus by causing the audio driver to play an audio signal on the speaker. In one or more implementations, the processor can determine a delta pressure by subtracting the second measurement, which includes the measurement of the second pressure, from the first measurement, which includes the measurement of the first pressure, and comparing the delta pressure with a predetermined value. In some embodiments, the processor reports a leak of the housing based on a comparison of the delta pressure with the predetermined value.

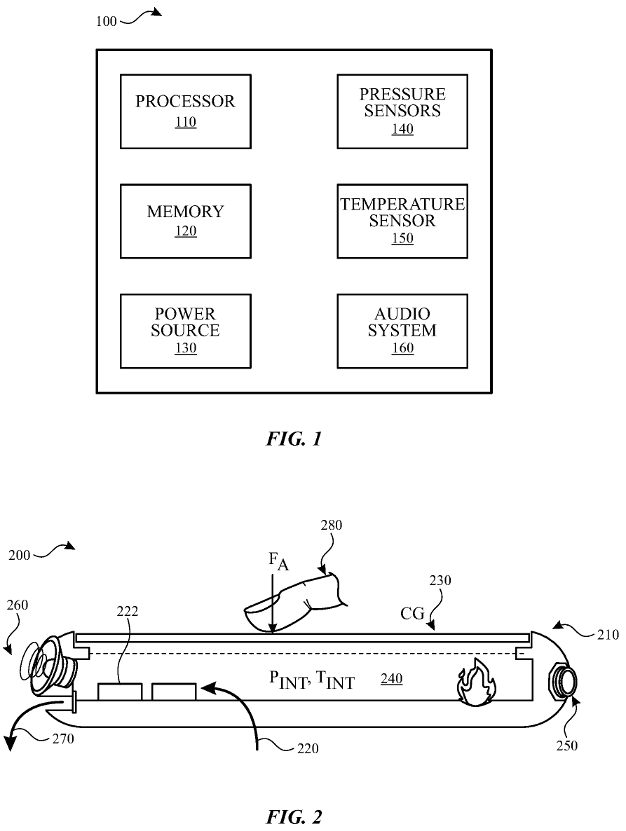

FIG. 1 is a high-level block diagram illustrating an example of a system 100 within which certain aspects of the subject technology are implemented. In some embodiments, the system 100 can be, but is not limited to, an electronic device such as a hand-held communication device, for example a watch (e.g., a smartwatch), or a phone (e.g., a smartphone). In some embodiments, the system 100 is enclosed in a sealed housing that prevents water, and other liquids, ingress. The system 100 includes, but is not limited to, a processor 110, a memory 120, a power source 130, one or more pressure sensors 140, a temperature sensor 150, and an audio system 160. The processor 110 can be a general processor of the electronic device or a dedicated processor. The one or more pressure sensors 140 include at least one internal pressure sensor and one external pressure sensor for measuring an internal pressure of the cavity of the housing and the external pressure, respectively.

In an example, the power source 130 is used to charge a power source (e.g., battery) of the apparatus 100. The charging of the power source, for example, can result in a temperature increase inside the cavity of the housing. The temperature change inside the housing can be measured by the temperature sensor 150. In some embodiments, the processor 110 uses the measured pressures of the internal and external pressure sensor to detect a leak in a seal of the housing. The audio system 160 may include, but is not limited to, an audio driver and one or more speakers. The audio driver generates electrical signals with frequencies within an audio band (e.g., a few Hz to about 20 KHz), and provides the electrical signal to the speaker(s) to be played as an audio signal. In some embodiments, tones with other frequencies, for example, frequencies inaudible to humans can also be used. In some embodiments, the processor 110 uses the audio system 160 to diagnose a leak in the seal of the housing, as discussed in more details herein. In some embodiments, the processor 110 can use the temperature rise of the cavity of the housing due to charging by the power source 130 to detect a leak of the housing. The processor 110 can use the memory 120 to store information including pressure changes, temperature changes, and other useful information.

FIG. 2 is a schematic diagram illustrating an example of an apparatus 200 using a seal-integrity diagnostic system, according to one or more implementations of the subject technology. In some embodiments, the apparatus 200 is, but is not limited to, an electronic device such as a hand-held communication device, for example, a watch (e.g., a smartwatch), or a phone (e.g., a smartphone). The apparatus 200 includes, but is not limited to, a housing 210, a first pressure sensor 220, a temperature sensor 222, a cover glass (CG) 230, a cavity 240, a second pressure sensor 250, a speaker 260, and a vent 270. The apparatus 200 also can include a processor, memory, a power source, an audio driver, and a temperature sensor that are parts of the of the seal-integrity diagnostic system but not shown in FIG. 2 for clarity.

In some embodiments, the first pressure sensor 220 is a barometric pressure sensor internal to the apparatus 200 and can effectively measure the pressure (P_{INT}) inside a constant volume of the cavity 240 at a given temperature (TINT). The first pressure sensor 220 can output a known pressure signal in response to known inputs. However, if the seal of the apparatus 200 is breached, the cavity cannot be considered a constant volume system anymore, and the pressure response to the known input would deviate from the sealed system response. In some embodiments, the second pressure sensor 250 can be used for calibration of the first pressure sensor 220, the discussion of which is not within the scope of the present disclosure. The apparatus 200 can use a number of stimuli (inputs) that can cause pressure change inside the cavity 240 for the seal-integrity diagnostic. Examples of the stimuli include, but are not limited to, acoustic, touch, and temperature inputs such as thermal virus, as discussed herein.

In some embodiments, when an audio is played on the speaker 260, the movement of the speaker membrane would displace air inside the cavity 240. In some embodiments, the speaker 260 is an internally ported speaker or uses the cavity 240 as a back volume. The air displacement would generate a pressure change, which can vary with the level of seal degradation. The level of seal degradation could be measured either from the amplitude, or decay-time constant of the output of the first pressure sensor 220. For example, the processor (e.g., 110 of FIG. 1) can receive the output of the first pressure sensor 220 as pressure signals, and analyze the signals to retrieve the amplitude and time constant.

In some embodiments, the processor may activate a pressure-change stimulus by causing an audio driver to play an audio signal on the speaker 260, which results in pressure change in the cavity 240. In some embodiments, the processor may periodically run a seal-quality metric evaluation by causing the audio driver to play an audio on the speaker 260. The processor may analyze the corresponding signals received from the first pressure sensor 220 and make a database of periodic runs by storing the measured amplitude and time constant values in the memory.

In some embodiments, touching or pressing the CG 230 of the apparatus display by an input device, such as, but not limited to, a finger 280 of a user, can deform the CG 230, which effectively reduces the volume of the cavity 240. When the housing 210 is sealed, the decrease in the volume of the cavity 240 would produce a pressure change inversely proportional to the volume. If the seal of the housing 210 is degraded, the resulting air leaks produce a weaker pressure signal from the first pressure sensor 220, which can be used by the processor to determine the presence of a seal leak and/or a level of seal degradation. In some embodiments, a user of the apparatus may enter a respective user interface (UI) on the apparatus 200 and touch (press) the CG 230 before entering water, for example, for swimming, scuba diving, or other water activities, and obtain a seal-integrity result shown on the display. For example, the processor may respond to the pressure change within the cavity 240 due to the touch-and-read signals from the first pressure sensor 220 for analysis and seal-integrity determination. The processor may report the result of the seal-integrity determination to the UI on the display, for example, by displaying “safe” when the seal integrity is not degraded, and “unsafe” when the seal integrity is breached. It is noted that the applied pressure-change stimulus has to be able to generate an internal pressure change faster than due to the vent 270.

In some embodiments, an increase in temperature of the air inside the cavity 240, e.g., while charging the power source or by means of a thermal virus, would lead to an increase in pressure. This is because of the ideal gas law (PV=nRT). A constant volume V of the cavity 240 results in a corresponding pressure change ΔP, which can be expressed as: ΔP=nRΔT/V, where ΔT represents the change in the temperature as measured by the temperature sensor 222. When the seal of the housing 210 is breached, the change in the pressure (ΔP) due to change in the temperature (ΔT) would ramp down, when a marginal seal failure is detected, or not exist at all when a gross seal failure is detected.

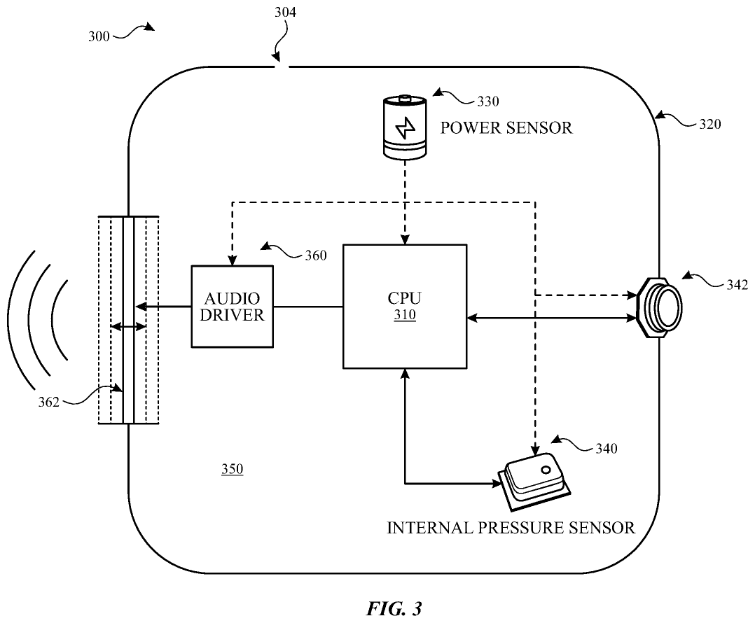

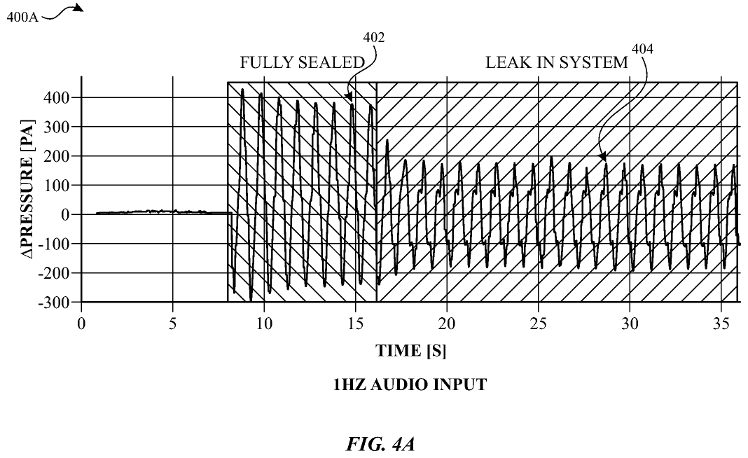

FIG. 3 is a schematic diagram illustrating an example of a system 300 with seal-integrity diagnostic features, according to one or more implementations of the subject technology. In some embodiments, the apparatus 300 is, but is not limited to, an electronic device such as a hand-held communication device, for example, a watch (e.g., a smartwatch), or a phone (e.g., a smartphone). The apparatus 300 includes, but is not limited to, a housing 302, a vent 304, a processor 310 (e.g., a central processing unit (CPU)), a power source 330, a first pressure sensor 340, a second pressure sensor 342, a cavity 350, an audio driver 360, and a speaker 362. The first pressure sensor 340 is an internal pressure sensor and measures an internal pressure as well as pressure change in the cavity 350. The second pressure sensor 342 is an external pressure sensor, and measures the external pressure.

In some embodiments, the processor 310 can use the audio driver to play an audio signal on the speaker 362, and analyze the pressure change measured by the first pressure sensor 340 to determine an amplitude and decay-time constant of the pressure signal received from the first pressure sensor 340.

In some embodiments, the processor 310 can use a touch stimulus, as discussed above with respect to FIG. 2, and determine whether it is safe or unsafe for the apparatus 300 to be exposed to a liquid (e.g., water), as described above with respect to FIG. 2.

In some embodiments, the processor 310 can use a temperature stimulus, as discussed above with respect to FIG. 2, and determine whether the seal integrity of the housing 302 is breached based on change in pressure (ΔP) due to the change in the temperature (ΔT). The change in the temperature can be due to the heat of charging the power source 330 by a charger or a thermal virus. The change in temperature (ΔT) leads to a change in pressure according to the ideal gas law (PV=nRT). Running a thermal virus creates a positive ΔT, which leads to a positive ΔP. Turning off the thermal virus would cause the pressure change ΔP to slowly decay down to zero, for which the decay constant can be calculated.

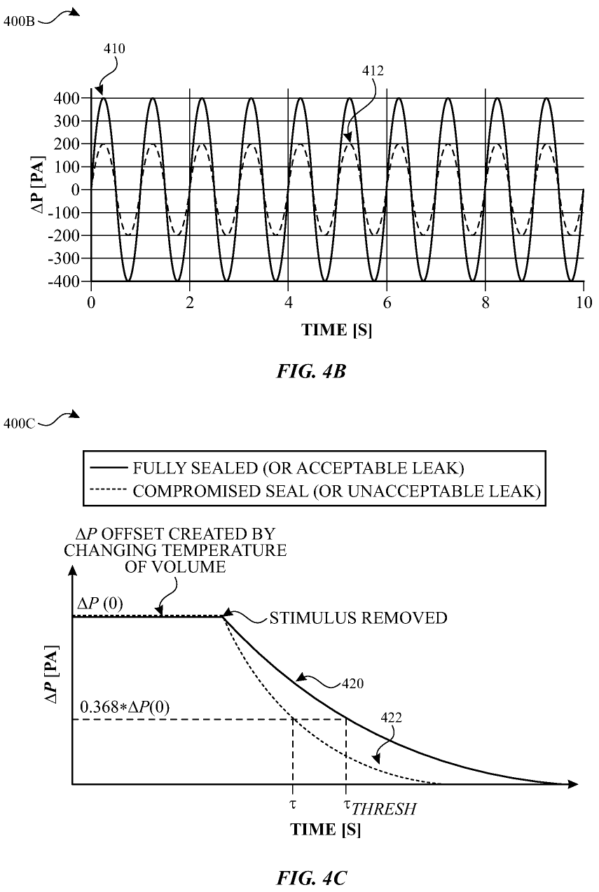

FIGS. 4A and 4B are charts 400A and 400B illustrating examples of pressure-change time variations of an acoustic seal-integrity diagnostic device, according to one or more implementations of the subject technology. As discussed above with respect to FIGS. 2 and 3, the processor 310 can analyze a response of the first pressure sensor 220 of FIG. 2 (or 340 of FIG. 3) to an audio stimulus caused by vibrations due to the speaker 260 of FIG. 2 (or 362 of FIG. 3) playing an audio signal. In the example of the chart 400A, the change in pressure (ΔP) versus time (in seconds) follows the audio signal, which is a sinusoidal signal with a frequency of about 1 Hz. The change in absolute values of amplitudes between sections 402 and 404 of the chart 400A can be used by the processor to determine whether a breach in the seal of the housing exists.

In some embodiments, the processor can also determine a decay-time constant of the sections 402 and 404 of the chart 400A, and utilize the decay-time constant to characterize a leak in the seal of the housing. The ΔP reading of section 402 is indicative of the seal integrity of a device being intact, whereas the ΔP reading of section 403 is indicative of the seal integrity of the device being compromised. In an example, if a pressure reading or ΔP is below a threshold value the device is considered to have a compromised seal. In an example, if the magnitude of a ΔP change exceeds a threshold the device is considered to have a compromised seal. In some embodiments, an audio frequency and amplitude input that produces the highest pressure change is desired to achieve the highest sensitivity. This frequency would change with the internal structure of the device. However, in general, lower the frequency, greater the speaker membrane displacement (within physical limits of the speaker). Also, using a frequency less than 20 Hz would be inaudible, making it a better user experience.

In some embodiments, after recording internal pressure change due to a stimulus (audio/temperature/touch), the change in pressure ΔP can be calculated in two ways using a first or a second method (or a combination of both, using sensor fusion algorithms, which is not within the scope of the present disclosure). In the first method, a pressure difference relative to the outside pressure (ΔP(t)=Pᵢₙₜ(t)−Pₑₓₜ(t)) is used. In the second method, a pressure difference relative to internal pressure at the start of algorithm (t=0) (ΔP(t)=Pᵢₙₜ(t)−Pᵢₙₜ (0)) is utilized. The benefit of using the external pressure sensor is that the changes in pressure due to environmental changes (e.g., due to turning on/off an air conditioning system, opening one or more doors and/or windows, etc.) can be cancelled out. Some quality metrics are defined and the threshold values are measured at the factory (fully sealed system) as calibration values by running the similar stimuli (acoustic, thermal virus or touch on the display) and measuring ΔP(t) for a predetermined time interval (e.g., 10 seconds). Examples of quality metrics include, but is not limited to, a root-mean-square (RMS) of ΔP(t) and a decay constant of ΔP(t).

As shown in the example chart 400B, for an acoustic input, ΔP(t) is a sinusoidal output, and the RMS of the output signal would give a single value for the signal. The chart 400B includes plots 410 and 412. The plot 410 shows a sinusoidal output measured at the factory on a fully sealed system with an RMS value ΔP_{rms,thresh} (e.g., 400/√2=282 Pa) saved in memory on the device. The plot 412 depicts a sinusoidal output measured when the same system is later run in the field. The measured RMS value ΔPᵣₘₛ (e.g., 141 Pa) is seen to be less than ΔP_{rms,thresh} (e.g., 282 Pa), which is an indication that a leak exist.

FIG. 4C is a chart 400C illustrating example plots 420 and 422 of time variations of pressure-change due to temperature change of an acoustic seal-integrity diagnostic device, according to one or more implementations of the subject technology. The plot 420 correspond to a fully sealed system (e.g., measured in the factory) and the plot 422 corresponds to a compromised seal measured in the field. Given a non-zero ΔP(t), and all stimuli turned off, ΔP(t) would slowly decay down to zero (e.g., as shown by plot 420). This is because all systems have some level of acceptable air leak (e.g., considered sealed for all practical purposes until certain water depth). A non-zero ΔP(t) can be created by change in temperature (e.g., running a speaker that generates heat) or change in cavity volume by touch. The decay constant t is a property defining the time it takes for ΔP(t) to decay down to 36.8% of its original value (ΔP(0)), as defined by an exponential expression (ΔP(t)=ΔP(0) e^{-t/}^{_{τ}}). A larger decay constant indicates a smaller leak rate. The decay constant measured at the factory on a fully sealed system τₜₕᵣₑₛₕ is saved in memory on the device. When the same system is later run in the field (e.g., plot 422), a decay-constant value τless than τₜₕᵣₑₛₕ would indicate a leak.

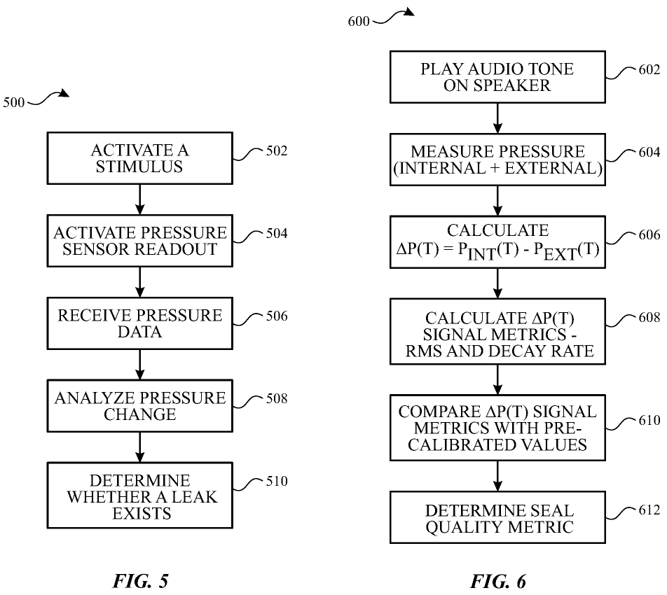

FIG. 5 is a flow diagram illustrating an example of a process 500 for seal-integrity diagnosis, according to one or more implementations of the subject technology. The process 500 is a process of seal-integrity diagnosis by using an internal pressure change of the cavity (e.g., 350 of FIG. 3) of an apparatus (e.g., an electronic device) such as the apparatus 300 of FIG. 3. The process 500 starts at operation block 502, where the processor 310 of FIG. 3 initiate the process by activating a stimulus, such as an audio stimulus, a touch stimulus, or a temperature stimulus. At operation block 504, the processor 300 activates a pressure-sensor readout by causing a readout circuit to read the pressure change resulting from the stimulus.

At operation block 506, the processor 300 receives pressure data such as a pressure-signal indicating a change in pressure of the cavity of the apparatus is response to the stimulus. At operation block 508, the processor 300 analyzes the pressure change, for example by analyzing amplitude and decay-time constant of the section 402 and 404 of the chart 400A of FIG. 4A. At operation block 510, the processor 300 determines a whether a leak exists in the seal of the housing (e.g., 302 FIG. 3). The processor 300 may report the result of the analysis to a UI installed on the electronic device to be suitably displayed to the user.

FIG. 6 is a flow diagram illustrating an example of a process 600 for acoustic seal-integrity diagnosis, according to one or more implementations of the subject technology. The process 600 is a process of seal-integrity diagnosis by using an internal pressure change of the cavity (e.g., 350 of FIG. 3) of an apparatus (e.g., an electronic device) such as the apparatus 300 of FIG. 3 due to an audio stimulus. The process 600 starts at operation block 602, where the processor 310 of FIG. 3 causes an audio driver (e.g., 360 of FIG. 3) to play an audio tone (e.g., as shown by the chart 400A of FIG. 4A) on the speaker (e.g., 362 of FIG. 3). At operation block 604, the processor 310 causes readout of the measured internal and external pressures of the cavity (e.g., 350 of FIG. 3) by the first pressure sensor (e.g., 340 of FIG. 3), and the second pressure senor (e.g., 342 of FIG. 3), respectively.

At operation block 606, the processor 310 calculates a pressure difference between the measured internal and external pressures of the cavity 350. At operation block 608, the processor 310 calculates pressure-change signal (ΔP(t)) metrics such as a root-mean square (RMS) of the signal and a decay-time constant. At operation block 610, the processor 310 compares the ΔP(t) signal metrics with a precalibrated value. At operation block 612, the processor 310 obtains the seal-quality metric based on the comparison of the ΔP(t) signal metrics with the precalibrated value.

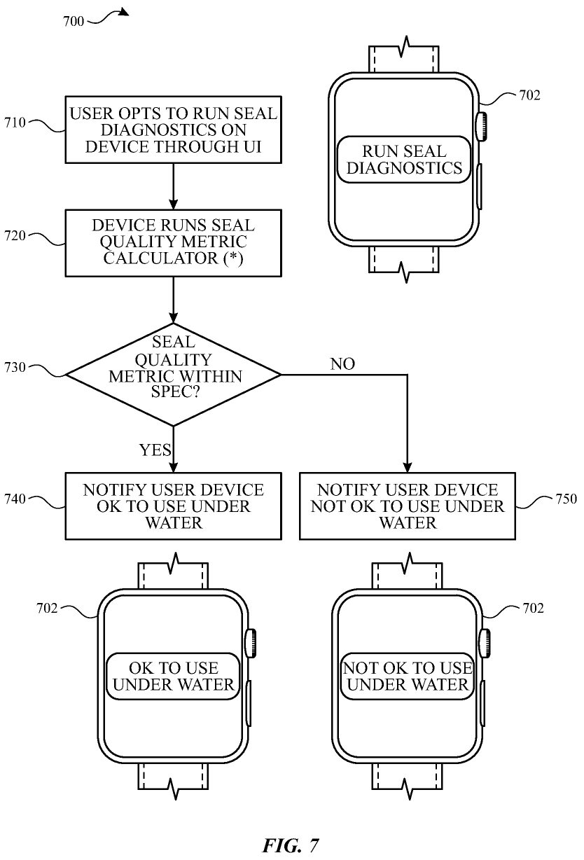

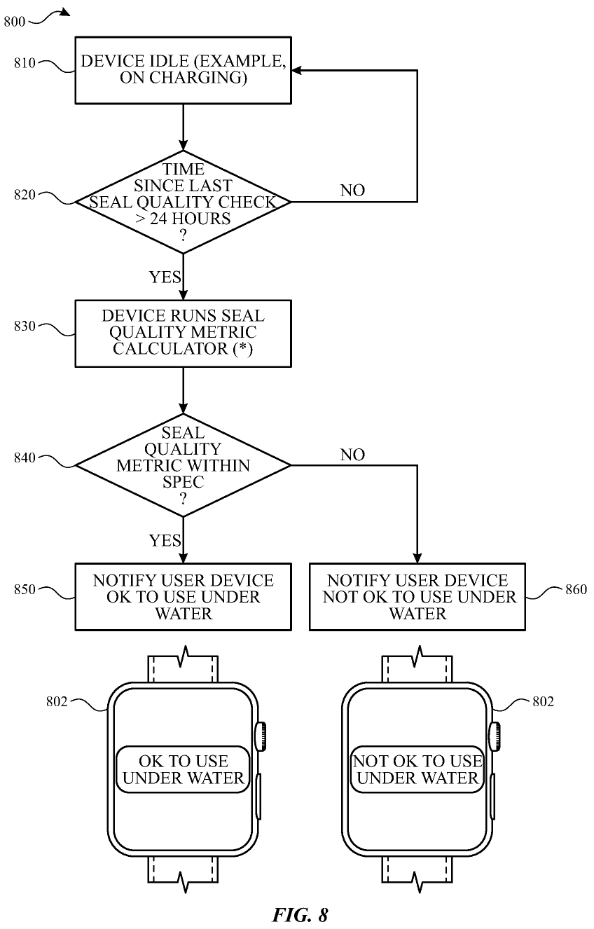

FIG. 7 is a flow diagram illustrating an example of a process 700 for seal-integrity diagnosis, according to one or more implementations of the subject technology. The process 700 starts at operation block 710, where the user of apparatus 300 of FIG. 3 (e.g., a device such as a smartwatch 702) decides to run a seal diagnostic on the device through a UI. At operation block 720, the processor (e.g., 310 of FIG. 3) of the device runs a seal-quality metric calculator application to obtain a seal-quality metric.

At operation block 730, the processor determines whether the obtained seal-quality metric is within a specification. If the obtained seal-quality metric is within the specification, at operation block 740, the processor 310 causes the UI to notify the user that it is fine to use the device 702 under the water. If the obtained seal-quality metric is not within the specification, at operation block 750, the processor 310 causes the UI to notify the user that the device 702 is not ready (e.g., may have a degraded seal) for being used under the water.

FIG. 8 is a flow diagram illustrating an example of a process 800 for seal-integrity diagnosis, according to one or more implementations of the subject technology. The process 800 starts at operation block 810, where a device such as the smartwatch is idle (e.g., charging). At operation block 820, the processor (e.g., 310 of FIG. 3) of the device determines whether the lapsed time since the last seal-quality check is more than a pre-determined time (e.g., 24 hours). If the elapsed time is more than the pre-determined time, at operation block 830, the processor 310 runs a seal-quality metric calculator to find a seal-quality metric of the device. If the elapsed time not more than the pre-determined time, the processor 310 returns the control to the operation block 810.

At operation block 840, the processor 310 determines whether the obtained seal-quality metric is within a specification. If the obtained seal-quality metric is within the specification, at operation block 850, the processor 310 causes the UI to notify the user that it is fine to use the device 802 under the water. If the obtained seal-quality metric is not within the specification, at operation block 860, the processor 310 causes the UI to notify the user that the device 802 is not ready (e.g., may have a degraded seal) for being used under the water.

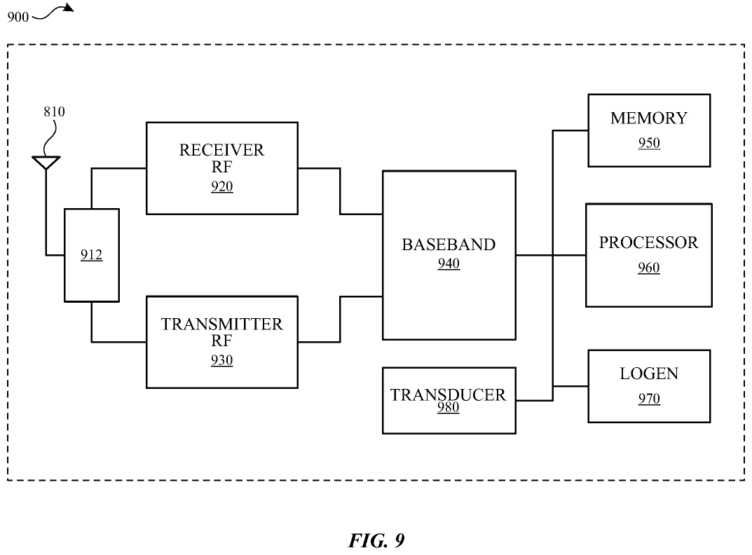

FIG. 9 is a schematic diagram illustrating an example of an electronic device 900 within which aspects of the subject technology may be implemented. In some aspects, the electronic device 900 may represent a communication device (e.g., a smartphone, or smartwatch), a tablet, a laptop, or any other electronic device. The electronic device 900 may comprise a radio frequency (RF) antenna 910, a receiver 920, a transmitter 930, a baseband processing module 940, a memory 950, a processor 960, a local oscillator generator (LOGEN) 970, and a transducer 980. In various embodiments of the subject technology, one or more of the blocks represented in FIG. 9 may be integrated on one or more semiconductor substrates. The blocks 920-970, for example, may be realized on a single chip, a single system on a chip, or on a multi-chip chipset.

The RF antenna 910 may be suitable for transmitting and/or receiving RF signals (e.g., wireless signals) over a wide range of frequencies. Although a single RF antenna 910 is illustrated, the subject technology is not so limited.

The receiver 920 may comprise suitable logic, circuitry, and/or code that may be operable to receive and process signals from the RF antenna 910. The receiver 920 may, for example, be operable to amplify and/or down-convert received wireless signals. In various embodiments of the subject technology, the receiver 920 may be operable to cancel noise in received signals, and may be linear over a wide range of frequencies. In this manner, the receiver 920 may be suitable for receiving signals in accordance with a variety of wireless standards, including Wi-Fi, WiMAX, Bluetooth, and other various cellular standards. In various embodiments of the subject technology, the receiver 920 may not require any SAW filters, and few or no off-chip discrete components, such as large capacitors, and inductors.

The transmitter 930 may comprise suitable logic, circuitry, and/or code that may be operable to process and transmit signals from the RF antenna 910. The transmitter 930 may, for example, be operable to up-convert baseband signals to RF signals and amplify RF signals. In various embodiments of the subject technology, the transmitter 930 may be operable to up-convert and amplify baseband signals processed in accordance with a variety of wireless standards. Examples of such standards may include Wi-Fi, WiMAX, Bluetooth, and other various cellular standards. In various embodiments of the subject technology, the transmitter 930 may be operable to provide signals for further amplification by one or more power amplifiers.

The duplexer 912 may provide isolation in the transmit band to avoid saturation of the receiver 920, damaging parts of the receiver 920, and/or to relax one or more design requirements of the receiver 920. Furthermore, the duplexer 912 may attenuate the noise in the receive band. The duplexer may be operable in multiple frequency bands for various wireless standards.

The baseband processing module 940 may comprise suitable logic, circuitry, interfaces, and/or code that may be operable to perform processing of baseband signals. The baseband processing module 940 may, for example, analyze received signals, generate control, and/or provide feedback signals for configuring various components of the electronic device 900, such as the receiver 920. The baseband processing module 940 may be operable to encode, decode, transcode, modulate, demodulate, encrypt, decrypt, scramble, descramble, and/or otherwise process data in accordance with one or more wireless standards. In some implementations, the baseband processing module 940 may include an intelligent boot circuit, and perform the functionalities of the intelligent boot of the subject technology, as described above.

The processor 960 may comprise suitable logic, circuitry, and/or code that may enable processing data and/or controlling operations of the electronic device 900. In this regard, the processor 960 may be enabled to provide control signals to various other portions of the electronic device 900. The processor 960 may also control transfers of data between various portions of the electronic device 900. Additionally, the processor 960 may enable the implementation of an operating system, or otherwise execute code to manage the operations of the electronic device 900.

In some implementations, the processor 960 may replace or execute some or all of the functionalities of the processor 310 of FIG. 3 as described above with respect to FIGS. 3, 5-8 to determine whether a seal of the electronic device 900 is breached, and to notify the user through a UI that that device is not ready to be used under water.

The memory 950 may comprise suitable logic, circuitry, and/or code that may enable the storage of various types of information, such as received data, generated data, code, and/or configuration information. The memory 950 may comprise, for example, RAM, ROM, flash, and/or magnetic storage. In various embodiments of the subject technology, information stored in the memory 950 may be utilized for configuring the receiver 920 and/or the baseband processing module 940.

The local oscillator generator (LOGEN) 970 may comprise suitable logic, circuitry, interfaces, and/or code that may be operable to generate one or more oscillating signals of one or more frequencies. The LOGEN 970 may be operable to generate digital and/or analog signals. In this manner, the LOGEN 970 may be operable to generate one or more clock signals and/or sinusoidal signals. Characteristics of the oscillating signals, such as the frequency and the duty cycle, may be determined based on one or more control signals from, for example, the processor 960 and/or the baseband processing module 940.

In operation, the processor 960 may configure the various components of the electronic device 900 based on a wireless standard according to which it is desired to receive signals. Wireless signals may be received via the RF antenna 910, amplified, and down converted by the receiver 920. The baseband processing module 940 may perform noise estimation and/or noise cancellation, decoding, and/or demodulation of the baseband signals. In this manner, information in the received signal may be recovered and utilized appropriately. For example, the information may be audio and/or video to be presented to a user of the electronic device, data to be stored in the memory 950, and/or information affecting and/or enabling the operation of the electronic device 900. The baseband processing module 940 may modulate, encode, and perform other processing on audio, video, and/or control signals to be transmitted by the transmitter 930 in accordance with various wireless standards.

In some implementations, the transducer 980 may be a pressure sensor, for example, an internal pressure sensor (e.g., 340 of FIG. 3) or an external pressure sensor (e.g., 342 of FIG. 3), and be used, as described above, to perform a seal-integrity diagnostic of the electronic device 900.

As used herein, the phrase “at least one of” preceding a series of items, with the terms “and,” or “or” to separate any of the items, modifies the list as a whole rather than each member of the list (i.e., each item). The phrase “at least one of” does not require selection of at least one of each item listed; rather, the phrase allows a meaning that includes at least one of any one of the items, at least one of any combination of the items, and/or at least one of each of the items. By way of example, the phrases “at least one of A, B, and C,” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but rather are intended to be used interchangeably. In one or more implementations, a processor configured to monitor and control an operation or a component, may also mean the processor being programmed to monitor and control the operation, or the processor being operable to monitor and control the operation. Likewise, a processor configured to execute code can be construed as a processor programmed to execute code or operable to execute code.

Phrases such as “an aspect,” “the aspect,” “another aspect,” “some aspects,” “one or more aspects,” “an implementation,” “the implementation,” “another implementation,” “some implementations,” “one or more implementations,” “an embodiment,” “the embodiment,” “another embodiment,” “a configuration,” “the configuration,” “another configuration,” “some configurations,” “one or more configurations,” “the subject technology,” “the disclosure,” “the present disclosure,” or any other variations thereof and alike are for convenience, and do not imply that a disclosure relating to such phrase(s) is essential to the subject technology, or that such disclosure applies to all configurations of the subject technology. A disclosure relating to such phrase(s) may apply to all configurations, or to one or more configurations. A disclosure relating to such phrase(s) may provide one or more examples. A phrase such as “an aspect,” or “some aspects,” may refer to one or more aspects and vice versa, and this applies similarly to other foregoing phrases.

The word “exemplary” is used herein to mean “serving as an example, instance, or illustration.” Any embodiment described herein as “exemplary” or as an “example,” is not necessarily to be construed as preferred or advantageous over other implementations. Furthermore, to the extent that the terms “include,” “have,” or the like are used in the description or the claims, such terms are intended to be inclusive in a manner similar to the term “comprise,” as “comprise” is interpreted when employed as a transitional word in a claim.

All structural and functional equivalents to the elements of the various aspects described throughout this disclosure that are known, or later come to be known, to those of ordinary skill in the art are expressly incorporated herein by reference, and are intended to be encompassed by the claims. Moreover, nothing disclosed herein is intended to be dedicated to the public, regardless of whether such disclosure is explicitly recited in the claims. No claim element is to be construed under the provisions of 35 U.S.C. § 112(f) unless the element is expressly recited using the phrase “means for,” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one,” unless specifically so stated, but rather “one or more.” Unless specifically stated otherwise, the term “some” refers to one or more. Pronouns in the masculine (e.g., his), include the feminine and neutral genders (e.g., her and its), and vice versa. Headings and subheadings, if any, are used for convenience only, and do not limit the subject disclosure.

What is claimed:

1. An apparatus, comprising:
a housing;
a first sensor configured to obtain a first measurement;
a second sensor configured to obtain a second measurement; and
a processor configured to determine a seal-quality metric of the housing based on the first measurement and the second measurement.

2. The apparatus of claim 1, wherein the first sensor comprises an internal pressure sensor disposed inside the housing, and the first measurement comprises measurement of an internal pressure of the housing.

3. The apparatus of claim 2, wherein the second sensor comprises an external pressure sensor disposed at an outside wall of the housing, and the second measurement comprises measurement of an external pressure.

4. The apparatus of claim 1, wherein the seal-quality metric is used to determine a level of a leak of the housing.

5. The apparatus of claim 1, wherein the processor is configured to activate a pressure-change stimulus to cause a change in pressure of an internal pressure of the housing.

6. The apparatus of claim 5, wherein the pressure-change stimulus comprises a touch stimulus, and wherein the processor is configured to activate the touch stimulus by sending a message to a user.

7. The apparatus of claim 5, wherein the apparatus further comprises an audio driver and a speaker, and wherein the pressure-change stimulus comprises an audio stimulus.

8. The apparatus of claim 7, wherein the processor is configured to activate the pressure-change stimulus by causing the audio driver to play an audio signal on the speaker.

9. The apparatus of claim 1, wherein the processor is configured to determine a delta pressure by subtracting the second measurement from the first measurement and comparing the delta pressure with a predetermined value.

10. The apparatus of claim 9, wherein the processor is configured to report a leak of the housing based on a comparison of the delta pressure with the predetermined value.

11. A device, comprising:
a housing;
a first pressure sensor configured to measure an internal pressure of the housing;
an audio driver configured to produce a sound to be played by a speaker; and
a processor configured to:
detect a change in the internal pressure of the housing caused by playing the sound, and
determine a seal-quality metric of the housing based on the change in the internal pressure.

12. The device of claim 11, wherein the processor is configured to activate the audio driver to play the sound on the speaker.

13. The device of claim 11, further comprising a second pressure sensor configured to measure an external pressure of the housing.

14. The device of claim 13, wherein the processor is configured to determine a delta-pressure by subtracting the external pressure from the internal pressure and comparing the delta-pressure with a predetermined value.

15. The device of claim 14, wherein the seal-quality metric is an indication of a level of a leak of the housing, and wherein the seal-quality metric is determined based on a comparison of the delta-pressure with the predetermined value.

16. The device of claim 15, wherein the processor is configured to report a leak of the housing based on the determined seal-quality metric.

17. A mobile communication device, the device comprising:
a first pressure sensor disposed in a housing and configured to measure an internal pressure of the housing;
an audio system including an audio driver and a speaker; and
a processor configured to:
monitor the measured internal pressure; and
determine a seal-quality metric of the housing based on a change in the internal pressure,
wherein the change in the internal pressure is caused by a sound produced by the audio driver and played on the speaker.

18. The device of claim 17, wherein the seal-quality metric is an indication of a level of a leak of the housing, and wherein the processor is configured to determine the seal-quality metric based on comparison of the change in the internal pressure with a predetermined value.

19. The device of claim 17, wherein the processor is configured to activate the audio driver to produce the sound and to play the sound on the speaker.

20. The device of claim 17, wherein the processor is further configured to receive a touch signal, and in response to receiving the touch signal, determine a failure of a seal of the housing based on a measured pressure change due to a touch of a screen.
